(19) United States
(12) Patent Application Publication
(10) Pub. No.: US 2026/0099322 A1
(43) Pub. Date: Apr. 9, 2026

(54) GENERATING SIMULATION CODE FROM IMAGES

(71) Applicant: NVIDIA CORPORATION, Santa Clara, CA (US)

(72) Inventors: Alexander ZOOK, Irvine, CA (US); Stanley BIRCHFIELD, Sammamish, WA (US); Valts BLUKIS, Seattle, WA (US); Josef Bo SPJUT, Cary, NC (US); Fan-Yun SUN, Stanford, CA (US); Jonathan TREMBLAY, Redmond, WA (US)

(21) Appl. No.: 19/284,507

(22) Filed: Jul. 29, 2025

Related U.S. Application Data
(60) Provisional application No. 63/703,092, filed on Oct. 3, 2024.

(51) Int. Cl. G06F 8/70; G06F 11/07; G06F 11/3668; G06T 7/11; G06V 10/764

(52) U.S. Cl. CPC G06F 8/70; G06F 11/0751; G06F 11/3684; G06T 7/11; G06V 10/764

(57) ABSTRACT

One embodiment of a method for generating simulation code includes generating first program code that simulates an environment in which a robot can perform a task and second program code that includes one or more tests; determining, using a first trained machine learning model, that one or more errors during execution of the first program code and the second program code are caused by at least one of the first program code or the second program code; and updating the at least one of the first program code or the second program code based on the one or more errors to generate at least one of updated first program code or updated second program code.

### CROSS-REFERENCE TO RELATED APPLICATIONS

This application claims priority benefit of the United States Provisional Patent Application titled, “TECHNIQUES FOR GENERATING ROBOTIC SIMULATION TASKS BASED ON REAL-WORLD IMAGES,” filed on Oct. 3, 2024 and having Ser. No. 63/703,092. The subject matter of this related application is hereby incorporated herein by reference.

### BACKGROUND

### Field of the Various Embodiments

The various embodiments relate generally to computer science, robotics, machine learning and artificial intelligence (AI), and, more specifically, to generating simulation code from images.

### Description of the Related Art

Vision-based robot control uses cameras and other imaging sensors to guide robotic systems in both structured and unstructured environments. By processing visual information—such as red, green, and blue (RGB) images, depth maps, and/or point clouds—robots can perceive objects, monitor the surrounding environment, and perform tasks. Vision-based robot control can support a variety of tasks, from grasping and moving objects to assembling parts and interacting with complex scenes.

One conventional approach for vision-based robot control uses a trained machine learning model to interpret camera data to detect obstacles, plan movements, and execute collision-free robot trajectories. For example, the machine learning model can be trained using reinforcement learning within a physics-based simulator that simulates a real-world environment. In such cases, the reinforcement learning allows the machine learning model to “practice” within the simulator and learn how to control a robot to perform a task, after which the trained machine learning model can be deployed to control a physical robot to perform that task in the real world.

One drawback of the above approach for vision-based robot control is the simulator must be designed to closely replicate behaviors that the robot will perform in the real world to accomplish a task. Only when such behaviors are replicated can the machine learning model be successfully trained using the simulator. However, few, if any, effective techniques currently exist for automatically designing simulators that match real-world scenes and simulate the robotic behaviors that are required for training a machine learning model. For example, a large language model (LLM) could be prompted to generate various tasks for a robot to perform and three-dimensional (3D) scenes in which to perform the tasks. However, the scenes generated by LLMs are oftentimes not functional and/or do not permit the tasks generated by the LLMs to be performed by a robot within those scenes.

As the foregoing illustrates, what is needed in the art are more effective techniques for generating program code for simulations.

### SUMMARY

One embodiment of the present disclosure sets forth a computer-implemented method for generating simulation code. The method includes generating first program code that simulates an environment in which a robot can perform a task and second program code that includes one or more tests. The method further includes determining, using a first trained machine learning model, that one or more errors during execution of the first program code and the second program code are caused by at least one of the first program code or the second program code. In addition, the method includes updating the at least one of the first program code or the second program code based on the one or more errors to generate at least one of updated first program code or updated second program code.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to the prior art is that the disclosed techniques automatically generate program code for simulators that match real-world images. The disclosed techniques can also generate tasks for robots to perform. Accordingly, the disclosed techniques combine scene understanding, asset population, task generation, and simulator generation, addressing the lack of integration in previous approaches. The generated simulators enable the simulation of robotic behaviors that are required for training machine learning models to perform the generated tasks. In particular, the disclosed techniques enable the generation of robust simulations that accomplish intended tasks with accuracy and reliability. Further, the disclosed techniques improve the rate of generating effective simulations compared to other techniques that only do code repair. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a more detailed illustration of the simulation generator of FIG. 1, according to various embodiments;

FIG. 5 is a more detailed illustration of the scene comprehension module of FIG. 4, according to various embodiments;

FIG. 6 is a more detailed illustration of the task generation module of FIG. 4, according to various embodiments;

FIG. 7 illustrates an exemplar prompt that the task generation module can input into the vision-language model (VLM) of FIG. 6, according to various embodiments;

FIG. 8 illustrates an exemplar task output by the task generation module of FIG. 6, according to various embodiments;

FIG. 9 is a more detailed illustration of the simulation generation module of FIG. 4, according to various embodiments;

FIG. 10 illustrates an exemplar test generated by the simulation generation module of FIG. 4, according to various embodiments;

FIG. 11 is a more detailed illustration of the simulation refinement module of FIG. 4, according to various embodiments;

FIG. 12 illustrates an exemplar prompt that the simulation refinement module of FIG. 11 can input into a large language model (LLM), according to various embodiments; and

FIG. 13 is a flow diagram of method steps for generating a simulation program, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating simulation programs. In some embodiments, given an image and 3D information of an environment for which a simulation program is to be generated, a simulation generator application segments the image using a segmentation model to generate a segmentation mask. The simulation generator prompts a vision-language model (VLM) to describe each candidate object that is manipulable in the image. The simulation generator then matches the candidate objects to assets in an asset database based on associated descriptions. Then, the simulation generator generates a scene description that includes a list of the assets, a description of each asset, and scene information that includes a location and dimensions (and/or orientation) of each asset. The simulation generator processes the image and the scene description using the VLM to generate a task for the robot to perform. The simulation generator then processes the image, the scene description, and the task using the VLM to generate a simulation program. In addition, the simulation generator processes the simulation program and the task using a large language model (LLM) to generate one or more tests for verifying the simulation program. Then, the simulation generator causes the simulation program and the tests to execute. The simulation generator asks an LLM to determine, based on the execution, whether there are any errors in the simulation program or the tests and, if so, which to fix next. The simulation generator then asks an VLM to fix the errors in the simulation program, if any, or an LLM to fix the errors in the tests, if any. Then, the simulation generator causes the updated simulation program and the tests to execute again. The foregoing process repeats until there are no errors in the simulation program or the tests.

Although described herein primarily with respect to robotic applications as a reference example, techniques disclosed herein are also applicable outside robotics, such as to video games. In video game development, similar challenges arise: converting real environments to interactive virtual spaces with meaningful objectives. In some embodiments, techniques disclosed herein can be applied to create video game levels with appropriate difficulty, generating game mechanics tied to physical objects, and/or ensuring player objectives are achievable—critical aspects of game design.

The techniques for generating simulation programs have many real-world applications. For example, the techniques can be used to generate simulation programs that simulate environments in which robots can perform tasks. Machine learning models can then be trained to control the robots in the simulated environments. Thereafter, the machine learning models can be deployed to control robots in real-world environments. As another example, the techniques disclosed herein can be used to generate video game levels that simulate real-world environments.

The above examples are not in any way intended to be limiting. As persons skilled in the art will appreciate, as a general matter, the techniques for generating simulation programs described herein can be implemented anywhere that simulation programs are required or useful.

### System Overview

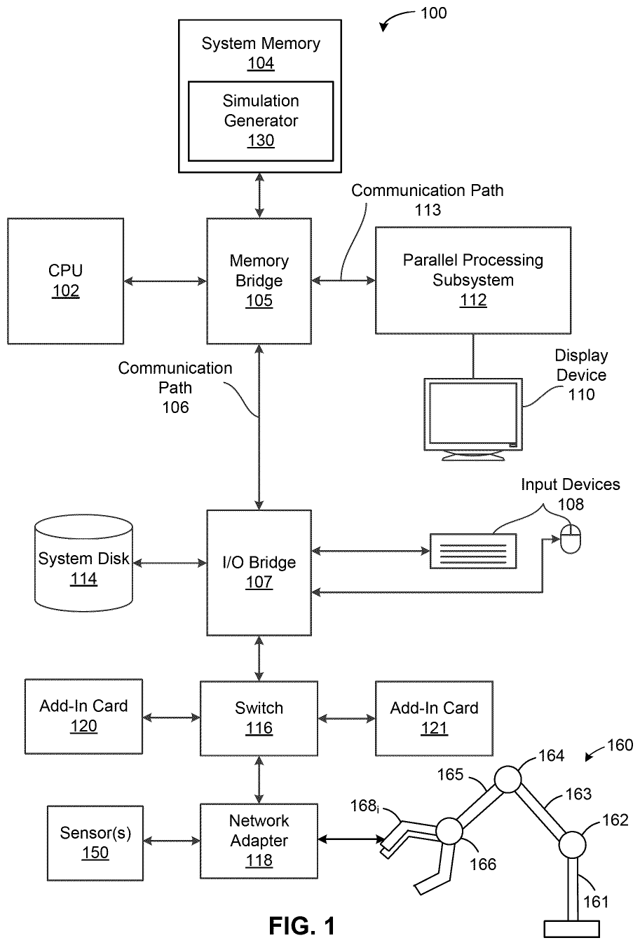

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 118. In one embodiment, switch 116 is configured to provide connections between I/O bridge 107 and other components of computer system 100, such as a network adapter 118 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

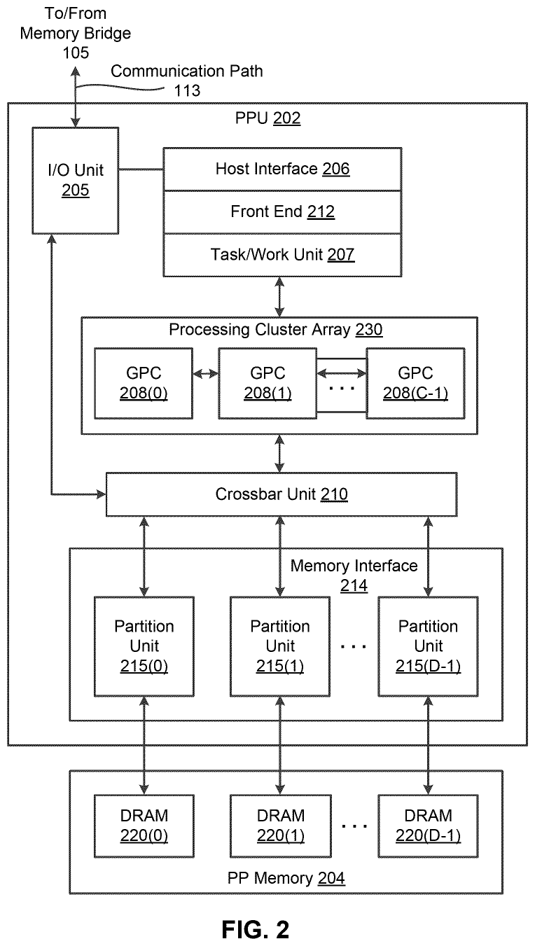

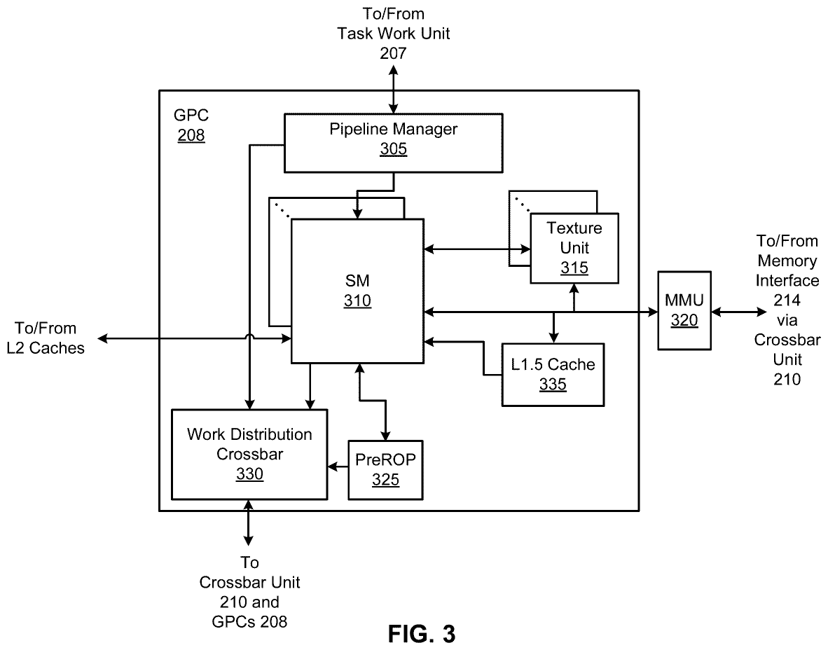

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

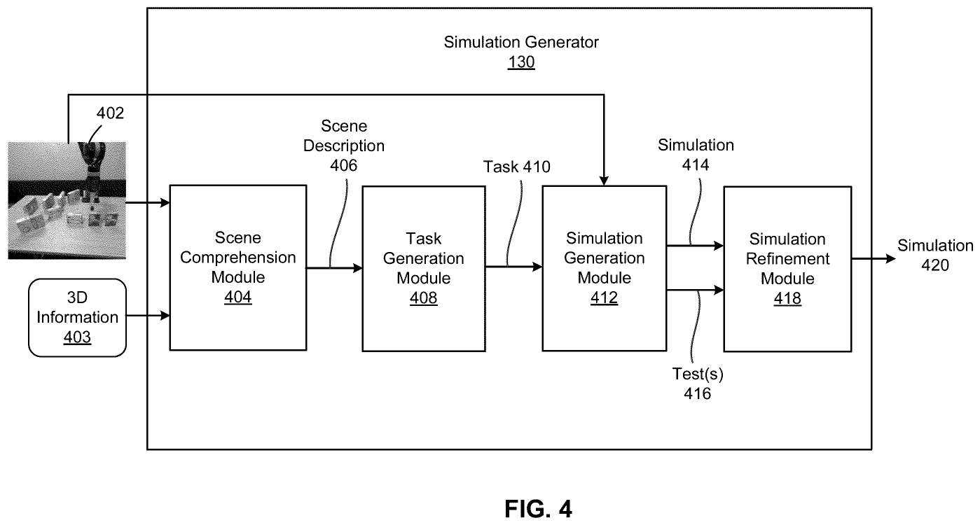

Illustratively, system memory 104 stores a simulation generator application (“simulation generator”) 130. In some embodiments, given an image and 3D information (e.g., depth data) of a physical environment, simulation generator 130 can generate program code for simulating an environment in which a robot can perform a task and program code for testing the simulation, as discussed in greater detail below in conjunction with FIGS. 4-13. A machine learning model (not shown) can be trained to control a robot in the simulated environment provided by the program code for the simulation, and the trained machine learning model can then be deployed to control a physical robot 160 based on sensor data acquired by one or more sensor(s) 150 (e.g., cameras, depth sensors, etc.). Although described herein primarily with respect to simulation generator 130 as a reference example, techniques disclosed herein can also be implemented, either entirely or in part, in other software and/or hardware, such as in parallel processing subsystem 112.

As shown, robot 160 includes multiple links 161, 163, and 165 that are rigid members, as well as joints 162, 164, and 166 that are movable components that can be actuated to cause relative motion between adjacent links. In addition, robot 160 includes multiple fingers 168ᵢ (referred to herein collectively as fingers 168 and individually as a finger 168) that can be controlled to grip an object. Although an example robot 160 is shown for illustrative purposes, in some embodiments, techniques disclosed herein can be applied to control any suitable robot.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC)

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other embodiments, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 118.

In some embodiments, CPU 102 is the master processor of computer system 100, controlling and coordinating operations of other system components. In one embodiment, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of CPU 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Generating Program Code for Simulations from Images

FIG. 4 is a more detailed illustration of simulation generator 130 of FIG. 1, according to various embodiments. As shown, simulation generator 130 includes, without limitation, a scene comprehension module 404, a task generation module 408, a simulation generation module 412, and a simulation refinement module 418. In operation, simulation generator 130 receives an image 402 and 3D information 403 of an environment as input. Scene comprehension module 404 processes the image 402 and 3D information 403 to generate a scene description 406. Task generation module 408 processes scene description 406 and image 402 to generate a task 410. Simulation generation module 412 processes image 402, scene description 406, and task 410 to generate a simulation program (“simulation”) 414 and a test program 416 that includes one or more tests (also referred to herein as “test(s) 416”). Simulation refinement module 418 executes and fixes simulation 414 and test(s) 416 until no errors remain, after which simulation refinement module 418 outputs a simulation 420 that does not include errors. Accordingly, simulation generator 130 is able to, beginning with image 402 and 3D information 403 of a real-world environment that includes a scene with various objects, automatically generate task 410 and associated rewards as well as simulation 414 that simulates an environment having a similar configuration as the real-world environment. Further, the foregoing process can be repeated to generate multiple tasks and associated simulations and tests.

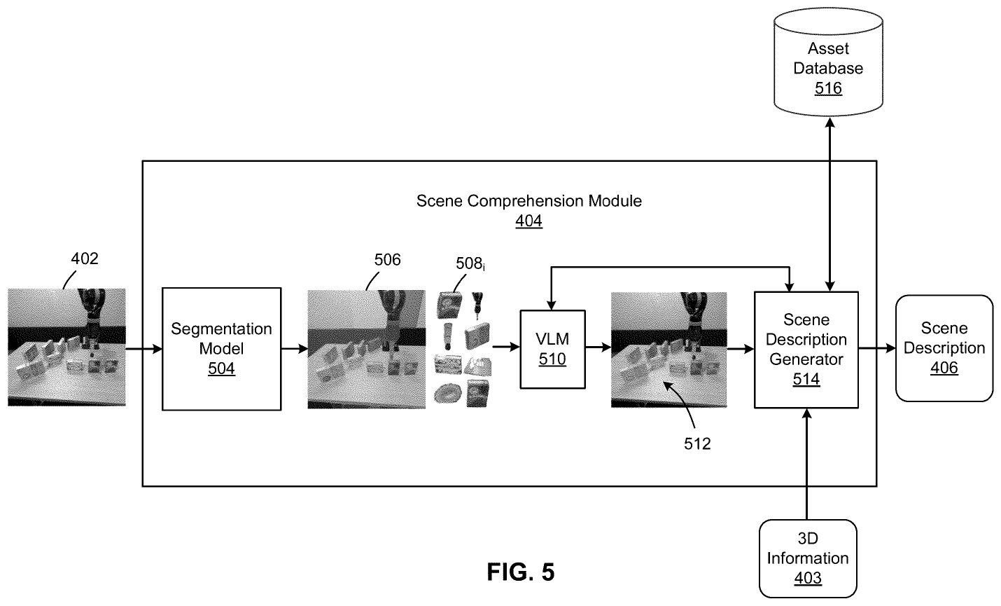

Scene comprehension module 404 processes image 402 and 3D information 403 to generate scene description 406. In some embodiments, image 402 and 3D information 403 can include the color and depth data, respectively, from an RGB-D (red, green, blue, depth) image. In some embodiments, given image 402 and 3D information 403, scene comprehension module 404 segments image 402 using a segmentation model to generate a segmentation mask. Scene comprehension module 404 then prompts a vision-language model (VLM) to describe each candidate object, identified using the segmentation mask, that is manipulable in image 402, and scene comprehension module 404 uses the VLM to match the candidate objects to assets in an asset database (not shown) based on associated descriptions. Although described herein primarily with respect to VLMs and large language models (LLMs) as reference examples, any technically feasible machine learning models (e.g., reasoning models, small language models, other language and/or multimodal models, etc.) can be used in some embodiments. For example, LLMs described herein can be replaced with VLMs in some embodiments. Then, the scene comprehension module 404 generates scene description 406 that includes a list of the assets, a description of each asset, and scene information that includes a location of each asset. Scene comprehension module 404 is described in greater detail below in conjunction with FIG. 5.

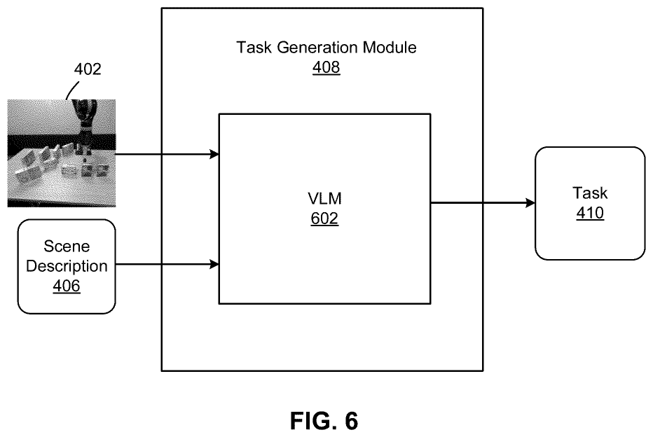

Task generation module 408 processes scene description 406 and image 402 to generate a task 410. In some embodiments, task generation module 408 processes scene information and asset descriptions from scene description 406, as well as image 402, using a VLM that generates task 410 for a robot to perform. By leveraging detailed scene understanding from scene description 406, task generation module 408 can generate tasks that are contextually appropriate to the scene in image 402 and feasible within a simulated environment. Task generation module 408 is described in greater detail below in conjunction with FIGS. 6-8.

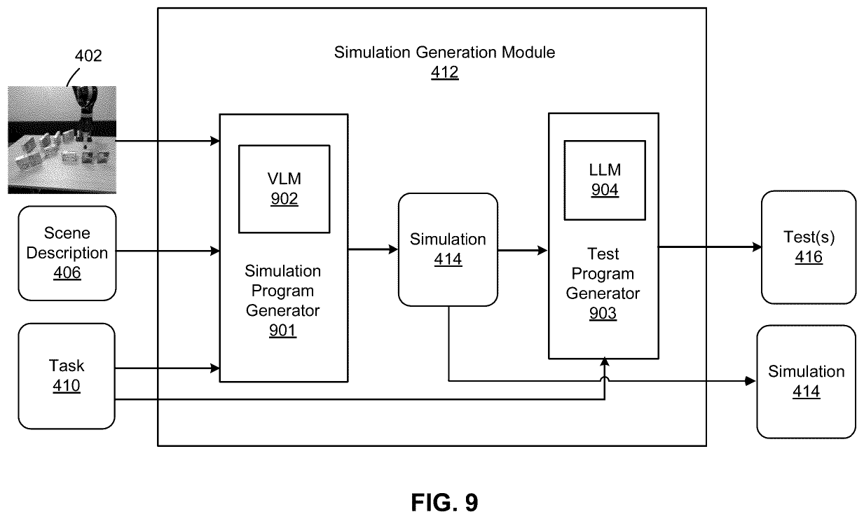

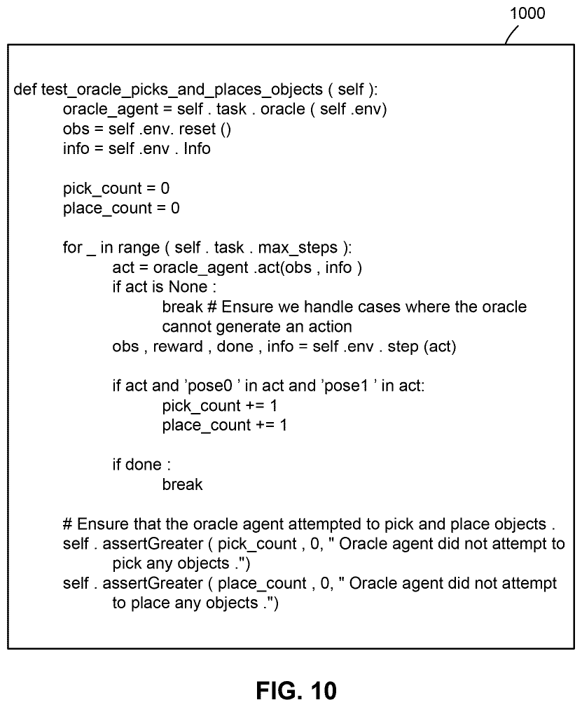

Simulation generation module 412 processes image 402, scene description 406, and task 410 to generate a simulation program (“simulation”) 414 and test programs (“tests”) 416. In some embodiments, simulation generation module 412 processes image 402, asset descriptions from scene description 406, and task 410 using a VLM that generates simulation 414. Then, simulation generation module 412 processes simulation 414 and task 410 using an LLM (or other language model) to generate test(s) 416 for verifying simulation 414. The LLM is used to author tests that are aligned with details of task 410 and scene information. Simulation generation module 412 is described in greater detail below in conjunction with FIGS. 9-10.

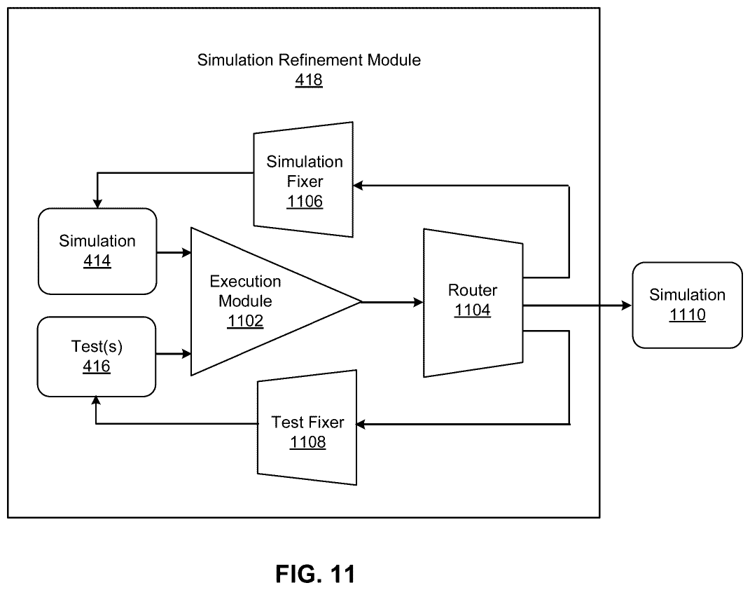

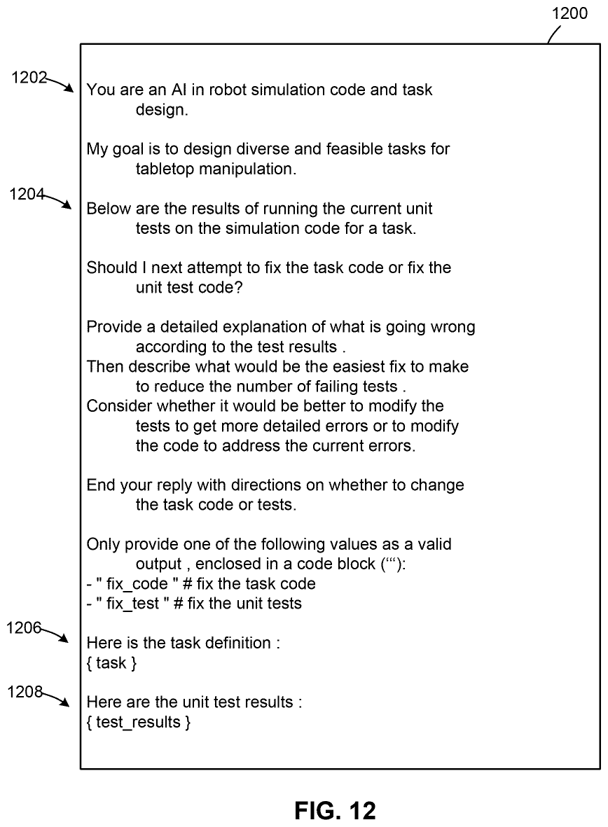

Simulation refinement module 418 executes and fixes simulation 414 and test(s) 416 until no errors remain, after which simulation refinement module 418 outputs a simulation 420 that does not include errors. In some embodiments, simulation refinement module 418 causes simulation 414 and test(s) 416 to execute in an execution environment, after which simulation refinement module 418 asks an LLM (or other language model) to determine, based on the execution, whether there are any errors in simulation 414 or test(s) 416, and, if so, which to fix next. Based on the output of the LLM, simulation refinement module 418 asks the VLM to fix errors in simulation 414, if any, or simulation refinement module 418 asks an LLM to fix errors in test(s) 416, if any. In some embodiments, either simulation 414 or test(s) 416 can be fixed at a time before a next execution. In some other embodiments, both simulation 414 and test(s) 416 can be fixed at once before a next execution. Then, simulation refinement module 418 causes the updated simulation program and the tests to execute again, and simulation refinement module 418 repeats the foregoing steps, which are also referred to herein as a “router” technique, until there are no errors in the simulation program or the tests. The router technique allows for continuous improvement of both simulations and tests, ensuring practicality and executability. In that regard, the router technique analyzes simulation performance, including runtime errors and test outcomes, and the router technique makes decisions on whether to refine the simulation or adjust the tests, iteratively improving both simulations and test cases until a robot control policy successfully completes task 410. Simulation refinement module 418 is described in greater detail below in conjunction with FIGS. 11-12.

In some embodiments, simulation generator 130 can generate simulation 420 according to the pseudo-code of Algorithm 1.

Algorithm 1: Simulation Generation Algorithm

| | |
|---|---|
| 1: | procedure TASKGENERATION |
| 2: | Inputs: image, scene description |
| 3: | Outputs: simulation, tests |
| 4: | simulation, tests ← VLM(image, scene description) |
| 5: | repeat |
| 6: | error ←Evaluate(simulation, tests) |
| 7: | if error /= Ø then |
| 8: | route based on error: |
| 9: | a) fix simulation, or |
| 10: | b) fix tests |
| 11: | end if |
| 12: | until error = Ø |
| 13: | Return: simulation, tests |
| 14: | end procedure |

FIG. 5 is a more detailed illustration of scene comprehension module 404 of FIG. 4, according to various embodiments. As shown, scene comprehension module 404 includes, without limitation, a segmentation model 504, a VLM 510, and a scene description generator 514. Scene comprehension module 404 is responsible for scene compression and initial state acquisition in order to build a detailed representation of the environment, namely scene description 406. In operation, scene comprehension module 404 receives as input image 402 and 3D information 403. Scene comprehension module 404 inputs image 402 into segmentation model 504, which generates a segmentation mask 506 in which each pixel has been assigned a label indicating an object to which the pixel is predicted to belong. Then, scene comprehension module 404 inputs each segmented component 508ᵢ (referred to herein collectively as segmented components 508 and individually as a segmented component 508), which is a portion of image 402 that is indicated by segmentation mask 506 to belong to a single object, into VLM 510 along with a prompt asking VLM 510 to (1) determine whether the object is manipulable, and (2) if the object is manipulable, describe the object. By doing so, scene comprehension module 404 can obtain a set of candidate objects 512 that are manipulable and associated descriptions. Then, scene description generator 514 compares the candidate object 512 descriptions and the cropped real image to descriptions of known assets in an asset database 516. Scene description generator 514 generates scene description 406 that includes a list of scene assets that are assets in asset database 516 whose descriptions match the descriptions of candidate objects 512, descriptions of the scene assets, and spatial representations of the assets.

Segmentation model 504 is a trained machine learning model, such as a neural network, that is trained to assign a label to each pixel in an image, effectively dividing the image into different regions or segments. The label assigned to each pixel can indicate which object the pixel is predicted to belong to. For example, segmentation model 504 could be a SAM2 (Segment Anything Model 2) model in some embodiments. In some embodiments, scene comprehension module 404 can utilize segmentation model 504 to segment image 402 into crops, which can result in oversegmentation of object parts and background elements. Such a granular detail provides a foundation for nuanced scene understanding.

In some embodiments, scene comprehension module 404 also maps each crop to a 3D bounding box by using 3D information 403 to transform segmented pixels to 3D positions in the robot coordinate frame, then fits the transformed segmented pixels within axis-aligned bounding boxes. In such cases, scene comprehension module 404 maps each image crop to a 3D bounding box of the candidate object. For each crop, the segmented pixels are mapped to corresponding 3D positions using 3D information 403. Then, scene comprehension module 404 transforms the 3D coordinates into the robot coordinate frame through a calibrated transformation matrix to spatially align with the environment. Once in the robot coordinate frame, the candidate object position and extent can be fitted within an axis-aligned 3D bounding box, enabling reliable geometric matching.

VLM 510 is a trained machine learning model, such as a neural network, that is trained to process and understand both visual (e.g., images, videos) and textual (e.g., natural language) inputs and to output text. Although shown as being included in scene comprehension module 404 for illustrative purposes, in some embodiments, VLM 510 and other machine learning models described herein can execute elsewhere (e.g., in a cloud computing environment) and be accessed via, e.g., an API. In some embodiments, VLM 510 is prompted by scene comprehension module 404 to filter and identify objects that are manipulable by a robot arm. VLM 510 is also prompted by scene comprehension module 404 to analyze each segmented region, describing attributes such as shape, color, size, branding, text, and/or orientation.

Scene description generator 514 is a module configured to generate scene description 406 that is a structured representation of a scene captured in image 402. In some embodiments, scene description 406 can include a list of scene assets, associated descriptions, and location and dimensions (and/or orientation) of each asset (e.g., a bounding box around each asset). In some embodiments, an object correspondence technique is performed to link candidate objects with appropriate 3D assets for simulation. In such cases, the object correspondence technique involves three steps: (1) asset database 516 creation, (2) candidate object description, and (3) description comparison. Asset database 516 creation is a pre-processing step during which a database of 3D asset descriptions is created by prompting VLM 510 (or a different VLM) to analyze multiple renders of each asset. The asset database 516 creation step can generate rich, multiperspective descriptions of each 3D object in an asset library, shown as asset database 516. The asset database 516 creation step can be performed once, retaining the text description database for reuse when evaluating different target scenes.

During D the candidate object description step, scene comprehension module 404 uses VLM 510 to describe the candidate object 508 crops derived from the segmentation, described above. The descriptions are based solely on visual information, which helps ensure a consistent basis of comparison with the asset database. The candidate object description step occurs once per target scene, as each scene includes a different set of cropped images as output from the image segmentation.

During the description comparison step, scene description generator 514 uses VLM 510 to compare the candidate object text description and the cropped real image to the descriptions in asset database 516. In some embodiments, scene description generator 514 can prompt VLM 510 to identify, from a list of assets in asset database 516, which asset each candidate object matches based on the description of the candidate object, or if VLM 510 is not sufficiently confident of a match, indicate that the candidate object does not match any of the assets. Doing so matches each candidate object to a 3D asset in asset database 516 or identifies that there is no object in the cropped image (to address over-segmentation). Alternatively, in some embodiments, images of the candidate objects can be provided to VLM 510 rather than descriptions of the candidate objects. The description comparison step is also performed once per target scene.

FIG. 6 is a more detailed illustration of task generation module 408 of FIG. 4, according to various embodiments. As shown, task generation module 408 includes, without limitation, a VLM 602. In operation, task generation module 408 receives image 402 and scene description 406 as input. Task generation module 408 inputs scene information and asset descriptions from scene description 406, as well as image 402, into VLM 602, which outputs task 410.

VLM 602 is a trained machine learning model, such as a neural network, that is trained to process and understand both visual (e.g., images, videos) and textual (e.g., natural language) inputs and to output text. Although shown as being included in task generation module 408 for illustrative purposes, in some embodiments, VLM 602 and other machine learning models described herein can execute elsewhere (e.g., in a cloud computing environment) and be accessed via, e.g., an API. In some embodiments, VLM 602 and VLM 510 can be the same VLM.

Task 410 is a task for a robot to perform in the scene shown in image 402 and described by scene description 406. For example, if the scene includes an object, then the task could be to pick up the object, to pick up and place the object elsewhere, and/or the like. Task 410 is generated by VLM 602. In some embodiments, task 410 includes a text description of the goals and/or actions to be executed by the robot, and simulations 414 and 420 include program code that implements the task. In some embodiments, task 410 includes the name for a task, a description of the task, and assets being used to perform the task. Such a distinction separates conceptual instructions (task) and concrete implementations (simulation) in the framework.

The challenge of simulation generation lies in translating real-world objectives into a simulator-compatible program code for robot execution. The generated program code should precisely define a starting configuration of the simulator and a desired end state. The generated simulation should run without errors and be optimized for feasibility, allowing a robot policy to complete the simulation successfully within an acceptable time frame. In some embodiments, the simulation generation process is divided into two phases: 1) generating a task definition and selecting appropriate scene assets, performed by task generation module 408; and 2) writing the simulation program for the task, performed by simulation generation module 412. In such cases, both phases can be enhanced by incorporating scene images and using a VLM for input processing. In some embodiments, rather than using predefined assets, candidate assets and placements of the candidate assets are identified during object correspondence. Doing so allows the task generation to benefit from both the visual context of the scene and the textual descriptions of available assets.

As described, in some embodiments, task generation module 408 provides the scene information and asset descriptions in scene description 406, as well as image 402, as input to VLM 602. Further, task generation module 408 prompts VLM 602 to create a contextually relevant robotics task. To accommodate a variety of potential tasks, the task is allowed to use a subset of the observed assets. For example, the tasks can be both practical and challenging for robotic manipulation systems, such as tasks that involve manipulating objects within the scene in specific ways, such as stacking particular items or grouping objects by category. In some embodiments, task generation module 408 is able to create a wide range of tasks, from simple object manipulation to more complex spatial reasoning and organizational challenges, all tailored to the specific objects and layout present in a given scene. By leveraging the detailed scene understanding achieved through the segmentation and object correspondence processes, described above, the generated tasks can be not only diverse but contextually appropriate to the real scene and feasible within the simulated environment.

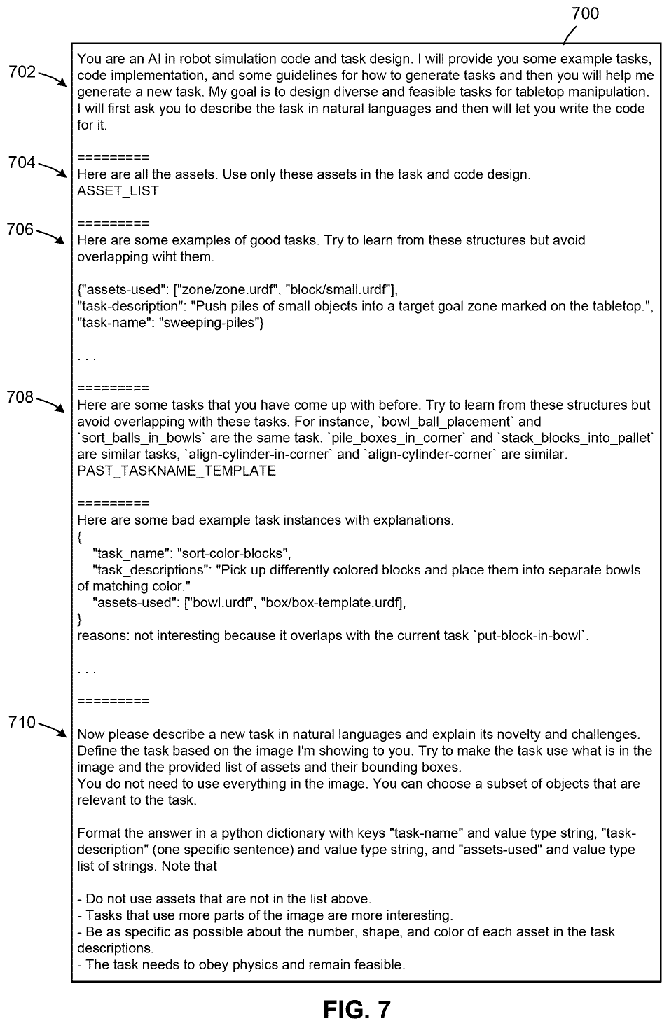

FIG. 7 illustrates an exemplar prompt that task generation module 408 can input into VLM 602 of FIG. 6, according to various embodiments. As shown, prompt 700 includes, without limitation, a system prompt 702, a list of assets 704 from scene description 406, examples of good tasks 706, examples of previously generated tasks 708, and instructions 710. Illustratively, system prompt 702 describes a role of VLM 602 as “You are an AI in robot simulation code and task design . . . .” Instructions 710 ask VLM 602 to describe a new task that uses a subset of objects from image 402 that are in the list of assets 704.

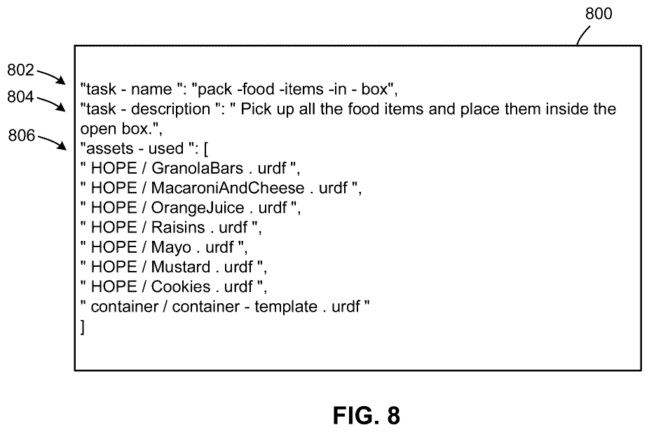

FIG. 8 illustrates an exemplar task output by task generation module 408 of FIG. 6, according to various embodiments. As shown, task 800 includes, without limitation, a name 802, a description 804, and a list of assets 806. Name 802 is a name given by VLM 602 to task 800. Illustratively, description 804 describes the task as “Pick up all the food items and place them inside the open box.” List of assets 806 indicates assets to be used in performing the task.

FIG. 9 is a more detailed illustration of simulation generation module 412 of FIG. 4, according to various embodiments. As shown, simulation generation module 412 includes, without limitation, a simulation program generator 901 and a test simulation generator 903. Simulation program generator 901 includes, without limitation, a VLM 902. Test simulation generator 903 includes, without limitation, an LLM 904. In operation, simulation generation module 412 receives image 402, scene description 406, and task 410 as inputs. Simulation program generator 901 processes image 402, asset descriptions from scene description 406, and task 410 using VLM 902, which generates simulation 414. Then, test simulation generator 903 processes simulation 414 and task 410 using LLM 904 to generate test(s) 416 for verifying simulation 414.

Simulation program generator 901 is a module of simulation generation module 412 that processes image 402, asset descriptions from scene description 406, and task 410 using VLM 610, which generates simulation 414. That is, to generate simulation 414 and test(s) 416, VLM 902 is provided image 402 of the scene, task 410, and asset descriptions from scene description 406. In some embodiments, simulation program generator 901 also inputs, into VLM 902, a prompt that includes the object bounding box positions as floats and strings referencing assets to load in the simulator. VLM 902 is permitted to modify the object list and positions during iteration on the task.

VLM 902 is a trained machine learning model, such as a neural network, that is trained to process and understand both visual (e.g., images, videos) and textual (e.g., natural language) inputs and to output text. Although shown as being included in task generation module 408 for illustrative purposes, in some embodiments, VLM 902 and other machine learning models described herein can execute elsewhere (e.g., in a cloud computing environment) and be accessed via, e.g., an API. In some embodiments, VLM 902, VLM 510, and VLM 602 can be the same VLM.

Simulation 414 includes program code for simulating an environment in which a robot can perform task 410. Any technically feasible program code can be generated by VLM 902. For example, the program code of simulation 414 could include low-level code for a physics engine, or the program code of simulation 414 could include high-level code that makes use of an existing physics engine. In some embodiments, simulation 414 can simulate an environment having a configuration that is similar to the configuration of a real-world environment in image 402, and simulation 414 can include code for verifying that task 410 is completed. The similar configuration can include the simulated environment having the same assets in the same positions as in the real-world environment. In some embodiments, the simulated environment can include a flat surface on which objects are placed, or the simulated environment can include a surface that is determined from 3D information, such as an uneven surface determined from depth information. For example, when the task is packing groceries into a box, simulation 414 could include code simulating the groceries and the box in particular locations, as well as code for verifying that the groceries are in the box.

Test simulation generator 903 is a module of simulation generation module 412 that processes simulation 414 and task 410 using LLM 904 to generate test(s) 416 for verifying simulation 414. That is, test simulation generator 903 analyzes the code of simulation 414 using LLM 904 and generates test(s) 416 for simulation 414.

Test(s) 416 include program code for testing that task 410 can be performed in simulation 414, which can include logic for how a robot operates to perform task 410 in simulation 414. To ensure the generated simulation 414 is valid for task 410, a battery of tests can be generated, intended to ensure task 410 can be completed by a robot policy. That is, test(s) 416 are specifically generated to evaluate the fidelity of simulation 414 to the task 410 description, ensuring a comprehensive validation process. In some embodiments, test simulation generator 903 generates test(s) 416 by providing simulation 414 and task 410 as input to LLM 904. In some embodiments, test(s) 416 could be implemented as python unit tests that use the ‘unittest’ library.

Focusing on robotic simulations suitable for policy execution or training, in some embodiments, test simulation generator 903 can prompt LLM 904 to write tests to ensure an oracle robot policy can succeed at task 410. The oracle robot policy is a robot policy having perfect knowledge of the state of a simulation, as opposed to making estimates based on sensor data. The ability of an oracle robot policy to succeed at task 410 indicates that task 410 can also be performed using a trained machine learning model that controls a robot. In some embodiments, the prompt can include API information for initializing a generic task in the simulator and calling an oracle agent in the simulator, along with a simplified execution loop for environment observation and action. Successful execution by an oracle agent is a stringent but valuable criterion, requiring error free code that specifies achievable objectives within the physical constraints of the simulator. Testing with an oracle incurs greater simulation generation and validation costs than unit tests that only check scene definition validity, but increases the likelihood of successful downstream task generation. By using LLM 904 to author the tests using an oracle, the task 410 details represent a feasible task for downstream applications training agents in the simulator. Returning to the example of packing groceries into a box, test(s) 416 could program code for operating a robot to pack the pack the groceries into the box and raise an error if task 410 cannot be completed, if task 410 is not completed within a specified time (e.g., 20 minutes), and/or the like.

FIG. 10 illustrates an exemplar test generated by simulation generation module 412 of FIG. 4, according to various embodiments. As shown, a test 1000 gets an oracle policy for a simulation environment and controls the oracle to perform certain actions within the simulation environment. In addition, test 1000 checks conditions, such as whether the oracle agent attempted to pick and place objects.

FIG. 11 is a more detailed illustration of simulation refinement module 418 of FIG. 4, according to various embodiments. As shown, simulation refinement module 418 includes, without limitation, an execution module 1102, a router 1104, a simulation fixer module (“simulation fixer”) 1106, and a test fixer module (“test fixer”) 1108. In operation, simulation generation module 412 receives as input simulation 414 and test(s) 416. Execution module 1102 causes simulation 414 and test(s) 416 to execute in an execution environment. Router 1104 is LLM that determines, based on the execution, whether there are any errors in simulation 414 or test(s) 416 and, if so, which to fix next. The errors can include compilation errors, errors during runtime, errors identified by tests, and/or the like. For example, simulation 414 could place objects in invalid locations, resulting in an error. As another example, simulation 414 could include incorrect logic for checking if a task has been completed. If there are error(s) in simulation 414, router 1104 routes simulation 414 and the simulation error(s) to simulation fixer 1106, which fixes the error(s) in simulation 414 using a VLM to generate an updated simulation, or if there are error(s) in test(s) 416, router 1104 routes test(s) 416 and the test error(s) to test fixer 1108, which fixes the error(s) in test(s) 416 using an LLM to generate updated tests. In some embodiments, either simulation 414 or test(s) 416 can be fixed at a time before a next execution. In some other embodiments, both simulation 414 and test(s) 416 can be fixed at once before a next execution. The foregoing steps are repeated until there are no errors in simulation 414 or test(s) 416, after which router 1104 outputs the simulation without errors, shown as simulation 1110.

Simulation refinement module 418 implements an iterative refinement technique, also referred to herein as a “router” or an “LLM router system,” which iteratively enhances both the simulation 414 and test(s) 416 until a policy successfully completes the prescribed task 410.

To align the task description and the generated simulation, an LLM router system is used to dynamically iterate over the simulation 414 and test(s) 416. The router technique follows a straightforward yet powerful approach: 1) Run Tests: Execute test(s) 416 on simulation 414 and collect any errors. 2) Router 1104: Use the task 410 description and error information to determine whether to update the generated test(s) 416 or simulation 414 program. 3) Fix: Revise the appropriate components using either a VLM for simulation code or an LLM for test code, considering inputs such as scene image, errors, and task definition. 4) Repeat the foregoing cycle until execution occurs without errors. The router technique is simple, yet effective, enabling simulation refinement module 418 to reason about the components of simulation generation and their relationships. In the router technique, router 1104 makes informed decisions on whether to refine simulation 414 or test(s) 416, optimizing the alignment process. By refining both simulation 414 and associated test(s) 416 using the task 410 definition as guidance, the router technique ensures alignment between the conceptual task 410 description and the practical implementation of task 410 in the simulated environment. Through iterative refinement, the router technique enables the generation of robust simulations that accomplish intended tasks with accuracy and reliability. Experience has shown that simulations for real-to-sim tasks can be generated using a single RGB-D observation. Further, the router technique improves the rate of generating effective simulations for robot policies compared to other techniques that only do code repair.

FIG. 12 illustrates an exemplar prompt that simulation refinement module 418 of FIG. 11 can input into an LLM, according to various embodiments. As shown, prompt 1200 includes, without limitation, a system prompt 1202, instructions 1204, a task definition 1206 of task 410, and results 1208 from running test(s) 416. Illustratively, system prompt 1202 describes a role of the LLM as “You are an AI in robot simulation code and task design . . . .” Instructions 1204 ask the LLM whether to fix the code of simulation 414 or test(s) 416 based on results of running test(s) 416 on simulation 414 for task 410.

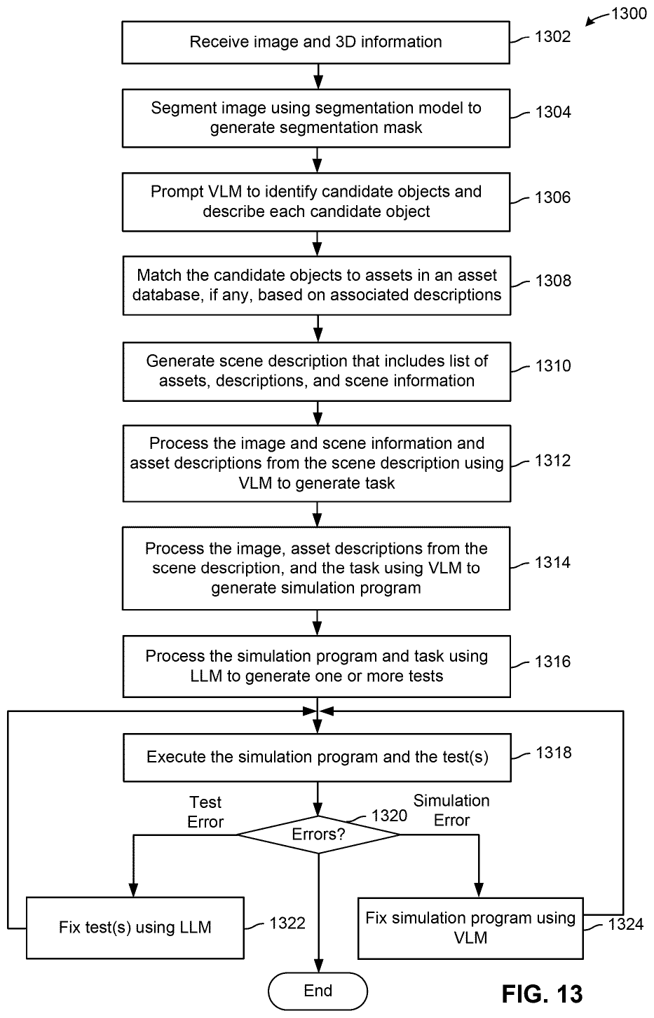

FIG. 13 is a flow diagram of method steps for generating a simulation program, according to various embodiments. Although the method steps are described in conjunction with the embodiments of FIGS. 1-12, persons skilled in the art will understand that any system configured to perform the method steps, in any order, falls within the scope of the present disclosure.

As shown, a method 1300 begins at step 1302, where simulation generator 130 receives an image (e.g., image 402) and 3D information (e.g., 3D information 403). For example, in some embodiments, simulation generator 130 can receive an RGB-D image of a physical scene.

At step 1304, simulation generator 130 segments the image using segmentation model 504 to generate a segmentation mask. As described, segmentation model 504 is a trained machine learning model, such as a neural network, that is trained to assign a label to each pixel in an image, effectively dividing the image into different regions or segments.

At step 1306, simulation generator 130 prompts VLM 510 to identify candidate objects and describe each candidate object. In some embodiments, scene comprehension module 404 inputs each segmented component which is a portion of the input image that is indicated by the segmentation mask to belong to a single object, into VLM 510 along with a prompt asking VLM 510 to (1) determine whether the object is manipulable, and (2) if the object is manipulable, describe the object, as described above in conjunction with FIGS. 4-5. By doing so, scene comprehension module 404 can obtain a set of candidate objects that are manipulable and associated descriptions.

At step 1308, simulation generator 130 matches the candidate objects to assets in an asset database, if any, based on associated descriptions. As described above in conjunction with FIGS. 4-5, in some embodiments, scene description generator 514 can prompt VLM 510 to identify, from a list of assets in asset database 516, which asset each candidate object matches based on the description of the candidate object, or if VLM 510 is not sufficiently confident of a match, indicate that the candidate object does not match any of the assets. Doing so matches each candidate object to a 3D asset in asset database 516 or identifies that there is no object in the cropped image (to address over-segmentation). Alternatively, in some embodiments, images of the candidate objects can be provided to VLM 510 rather than descriptions of the candidate objects.

At step 1310, simulation generator 130 generates a scene description that includes a list of scene assets, associated descriptions, and spatial representations of the assets. The scene assets are assets from the asset database that matched to candidate objects. In some embodiments, the scene description can include a list of scene assets and associated descriptions, as well as scene information that includes location and dimensions (and/or orientation) of each asset (e.g., a bounding box around each asset), as described above in conjunction with FIGS. 4-5.

At step 1312, simulation generator 130 processes the image and scene information and asset descriptions from the scene description using VLM 602 to generate a task. In some embodiments, task generation module 408 provides the scene information and asset descriptions in the scene description, as well as the image, as input to VLM 602, as task generation module 408 prompts VLM 602 to generate the task using one or more assets, as described above in conjunction with FIGS. 6-8.

At step 1314, simulation generator 130 processes the image, asset descriptions from the scene description, and the task using VLM 902 to generate a simulation program. In some embodiments, VLM 902 is provided the image of the scene, the task definition, and asset descriptions from the scene description, as described above in conjunction with FIG. 9. In some embodiments, simulation program generator 901 also inputs, into VLM 902, a prompt that includes the object bounding box positions as floats and strings referencing assets to load in the simulator. VLM 902 is permitted to modify the object list and positions during iteration on the task.

At step 1316, simulation generator 130 processes the simulation program and task using LLM 904 to generate one or more tests. In some embodiments, test simulation generator 903 analyzes code of the simulation using LLM 904 and generates test(s) for the simulation. The test(s) include program code for testing that the task can be performed in the simulation, which can include logic for how a robot operates to perform the task in the simulation. To ensure the generated simulation is valid for the task, a battery of tests can be generated, intended to ensure the task can be completed by a robot policy. In some embodiments, test simulation generator 903 generates test(s) by providing the simulation and the task as input to LLM 904, as described above in conjunction with FIGS. 9-10.

At step 1318, simulation generator 130 causes the simulation program and the test(s) to be executed. In some embodiments, the simulation program and test(s) can be executed in any technically feasible execution environment.

At step 1320, simulation generator 130 determines whether there are any errors. In some embodiments, simulation refinement module 418 can prompt an LLM (e.g., router 1104) to determine whether there are errors in the simulation or the test(s), as described above in conjunction with FIGS. 11-12. In some embodiments, the LLM can also be prompted to determine an error to fix next. If there are error(s) in the tests, then method 1300 continues to step 1322. If there are error(s) in the simulation program, then method 1300 continues to step 1324. If there are both test error(s) and simulation error(s), then both step 1322 and step 1324 can be performed in some embodiments. In some embodiments, either simulation 414 or test(s) 416 can be fixed at a time before a next execution. In some other embodiments, both simulation 414 and test(s) 416 can be fixed at once before a next execution.

At step 1322, simulation generator 130 fixes the tests using an LLM. In some embodiments, simulation refinement module 418 prompts an LLM to fix the test(s), providing the test(s), the test error(s), and the task definition to the LLM, as described above in conjunction with FIG. 11.

At step 1324, simulation generator 130 fixes the simulation program using a VLM. In some embodiments, simulation refinement module 418 prompts a VLM to fix the simulation program, providing the simulation program, the simulation program error(s), the image of the physical scene, and the task to the VLM, as described above in conjunction with FIG. 11.

On the other hand, if there are no errors at step 1320, then method 1300 ends. Thereafter, the generated simulation program can be used in any technically feasible manner, such as to provide the simulation environment for training a machine learning model to control a robot, as a video game level, and/or the like.

In sum, techniques are disclosed for generating simulation programs. Given an image and 3D information of an environment for which a simulation program is to be generated, a simulation generator application segments the image using a segmentation model to generate a segmentation mask. The simulation generator prompts a VLM to describe each candidate object that is manipulable in the image. The simulation generator then matches the candidate objects to assets in an asset database based on associated descriptions. Then, the simulation generator generates a scene description that includes a list of the assets, a description of each asset, and scene information that includes a location and dimensions (and/or orientation) of each asset. The simulation generator processes the image and the scene description using the VLM to generate a task for the robot to perform. The simulation generator then processes the image, the scene description, and the task using the VLM to generate a simulation program. In addition, the simulation generator processes the simulation program and the task using an LLM to generate one or more tests for verifying the simulation program. Then, the simulation generator causes the simulation program and the tests to execute. The simulation generator asks an LLM to determine, based on the execution, whether there are any errors in the simulation program or the tests and, if so, which to fix next. The simulation generator then asks an VLM to fix the errors in the simulation program, if any, or an LLM to fix the errors in the tests, if any. Then, the simulation generator causes the updated simulation program and the tests to execute again. The foregoing process repeats until there are no errors in the simulation program or the tests.

One technical advantage of the disclosed techniques relative to the prior art is that the disclosed techniques automatically generate program code for simulators that match real-world images. The disclosed techniques can also generate tasks for robots to perform. Accordingly, the disclosed techniques combine scene understanding, asset population, task generation, and simulator generation, addressing the lack of integration in previous approaches. The generated simulators enable the simulation of robotic behaviors that are required for training machine learning models to perform the generated tasks. In particular, the disclosed techniques enable the generation of robust simulations that accomplish intended tasks with accuracy and reliability. Further, the disclosed techniques improve the rate of generating effective simulations compared to other techniques that only do code repair. These technical advantages provide one or more technological improvements over prior art approaches.

1. In some embodiments, a computer-implemented method for generating simulation code comprises generating first program code that simulates an environment in which a robot can perform a task and second program code that includes one or more tests, determining, using a first trained machine learning model, that one or more errors during execution of the first program code and the second program code are caused by at least one of the first program code or the second program code, and updating the at least one of the first program code or the second program code based on the one or more errors to generate at least one of updated first program code or updated second program code.

2. The computer-implemented method of clause 1, wherein the first program code is generated using a second trained machine learning model and based on an image and three-dimensional (3D) information associated with a scene, and wherein the second program code is generated using a third trained machine learning model and based on the first program code and the task.

3. The computer-implemented method of clauses 1 or 2, wherein the first trained machine learning model comprises a language model, the second trained machine learning model comprises a vision-language model, and the third trained machine learning model comprises a language model.

4. The computer-implemented method of any of clauses 1-3, further comprising determining, using a second trained machine learning model and based on an image associated with a scene and one or more descriptions of one or more assets associated with the image, the task.

5. The computer-implemented method of any of clauses 1-4, further comprising segmenting the image using a third trained machine learning model to generate a segmentation mask, identifying, using the second trained machine learning model and based on the segmentation mask, one or more objects depicted in the image, and determining that the one or more descriptions of the one or more assets match descriptions of the one or more objects.

6. The computer-implemented method of any of clauses 1-5, further comprising determining three-dimensional (3D) information associated with the one or more assets based on the image and 3D information associated with the scene.

7. The computer-implemented method of any of clauses 1-6, wherein updating the at least one of the first program code or the second program code comprises processing the error, the first program code, and an image associated with a scene using a second trained machine learning model.

8. The computer-implemented method of any of clauses 1-7, wherein updating the at least one of the first program code or the second program code comprises processing the error and the second program code using a second trained machine learning model.

9. The computer-implemented method of any of clauses 1-8, wherein the one or more tests include a test of whether an oracle robot policy can succeed at the task within the environment that is simulated.

10. The computer-implemented method of any of clauses 1-9, further comprising training a second machine learning model to control the robot based on the updated first program code to generate a second trained machine learning model, and controlling the robot to move using the second trained machine learning model.

11. In some embodiments, one or more non-transitory computer-readable media store instructions that, when executed by at least one processor, cause the at least one processor to perform the steps of generating first program code that simulates an environment in which a robot can perform a task and second program code that includes one or more tests, determining, using a first trained machine learning model, that one or more errors during execution of the first program code and the second program code are caused by at least one of the first program code or the second program code, and updating the at least one of the first program code or the second program code based on the one or more errors to generate at least one of updated first program code or updated second program code.

12. The one or more non-transitory computer-readable media of clause 11, wherein the first program code is generated using a second trained machine learning model and based on an image and three-dimensional (3D) information associated with a scene, and wherein the second program code is generated using a third trained machine learning model and based on the first program code and the task.

13. The one or more non-transitory computer-readable media of clauses 11 or 12, wherein the instructions, when executed by the at least one processor, further cause the at least one processor to perform the step of determining, using a second trained machine learning model and based on an image associated with a scene and one or more descriptions of one or more assets associated with the image, the task.

14. The one or more non-transitory computer-readable media of any of clauses 11-13, wherein updating the at least one of the first program code or the second program code comprises processing the error, the first program code, and an image associated with a scene using a second trained machine learning model.

15. The one or more non-transitory computer-readable media of any of clauses 11-14, wherein updating the at least one of the first program code or the second program code comprises processing the error and the second program code using a second trained machine learning model.

16. The one or more non-transitory computer-readable media of any of clauses 11-15, wherein the instructions, when executed by the at least one processor, further cause the at least one processor to perform the steps of training a second machine learning model to control the robot based on the updated first program code to generate a second trained machine learning model, and controlling the robot to move using the second trained machine learning model.

17. The one or more non-transitory computer-readable media of any of clauses 11-16, wherein the instructions, when executed by the at least one processor, further cause the at least one processor to perform the steps of executing the updated first program code and the updated second program code, determining, using the first trained machine learning model, that one or more additional errors during execution of the updated first program code and the updated second program code are caused by at least one of the updated first program code or the updated second program code, and updating the at least one of the updated first program code or the updated second program code that caused the one or more additional errors to generate at least one of third program code or fourth program code.

18. The one or more non-transitory computer-readable media of any of clauses 11-17, wherein the updated first program code simulates at least one portion of a video game level.

19. The one or more non-transitory computer-readable media of any of clauses 11-18, wherein the one or more tests include one or more unit tests.

20. In some embodiments, a system comprises a memory storing instructions, and one or more processors, that when executing the instructions, are configured to perform the steps of generating first program code that simulates an environment in which a robot can perform a task and second program code that includes one or more tests, determining, using a first trained machine learning model, that one or more errors during execution of the first program code and the second program code are caused by at least one of the first program code or the second program code, and updating the at least one of the first program code or the second program code based on the one or more errors to generate at least one of updated first program code or updated second program code.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating simulation code, the method comprising:
generating first program code that simulates an environment in which a robot can perform a task and second program code that includes one or more tests;
determining, using a first trained machine learning model, that one or more errors during execution of the first program code and the second program code are caused by at least one of the first program code or the second program code; and
updating the at least one of the first program code or the second program code based on the one or more errors to generate at least one of updated first program code or updated second program code.

2. The computer-implemented method of claim 1, wherein the first program code is generated using a second trained machine learning model and based on an image and three-dimensional (3D) information associated with a scene, and wherein the second program code is generated using a third trained machine learning model and based on the first program code and the task.

3. The computer-implemented method of claim 2, wherein the first trained machine learning model comprises a language model, the second trained machine learning model comprises a vision-language model, and the third trained machine learning model comprises a language model.

4. The computer-implemented method of claim 1, further comprising determining, using a second trained machine learning model and based on an image associated with a scene and one or more descriptions of one or more assets associated with the image, the task.

5. The computer-implemented method of claim 4, further comprising:
segmenting the image using a third trained machine learning model to generate a segmentation mask;
identifying, using the second trained machine learning model and based on the segmentation mask, one or more objects depicted in the image; and
determining that the one or more descriptions of the one or more assets match descriptions of the one or more objects.

6. The computer-implemented method of claim 4, further comprising determining three-dimensional (3D) information associated with the one or more assets based on the image and 3D information associated with the scene.

7. The computer-implemented method of claim 1, wherein updating the at least one of the first program code or the second program code comprises processing the error, the first program code, and an image associated with a scene using a second trained machine learning model.

8. The computer-implemented method of claim 1, wherein updating the at least one of the first program code or the second program code comprises processing the error and the second program code using a second trained machine learning model.

9. The computer-implemented method of claim 1, wherein the one or more tests include a test of whether an oracle robot policy can succeed at the task within the environment that is simulated.

10. The computer-implemented method of claim 1, further comprising:
training a second machine learning model to control the robot based on the updated first program code to generate a second trained machine learning model; and
controlling the robot to move using the second trained machine learning model.

11. One or more non-transitory computer-readable media storing instructions that, when executed by at least one processor, cause the at least one processor to perform the steps of:
generating first program code that simulates an environment in which a robot can perform a task and second program code that includes one or more tests;
determining, using a first trained machine learning model, that one or more errors during execution of the first program code and the second program code are caused by at least one of the first program code or the second program code; and
updating the at least one of the first program code or the second program code based on the one or more errors to generate at least one of updated first program code or updated second program code.

12. The one or more non-transitory computer-readable media of claim 11, wherein the first program code is generated using a second trained machine learning model and based on an image and three-dimensional (3D) information associated with a scene, and wherein the second program code is generated using a third trained machine learning model and based on the first program code and the task.

13. The one or more non-transitory computer-readable media of claim 11, wherein the instructions, when executed by the at least one processor, further cause the at least one processor to perform the step of determining, using a second trained machine learning model and based on an image associated with a scene and one or more descriptions of one or more assets associated with the image, the task.

14. The one or more non-transitory computer-readable media of claim 11, wherein updating the at least one of the first program code or the second program code comprises processing the error, the first program code, and an image associated with a scene using a second trained machine learning model.

15. The one or more non-transitory computer-readable media of claim 11, wherein updating the at least one of the first program code or the second program code comprises processing the error and the second program code using a second trained machine learning model.

16. The one or more non-transitory computer-readable media of claim 11, wherein the instructions, when executed by the at least one processor, further cause the at least one processor to perform the steps of:
training a second machine learning model to control the robot based on the updated first program code to generate a second trained machine learning model; and
controlling the robot to move using the second trained machine learning model.

17. The one or more non-transitory computer-readable media of claim 11, wherein the instructions, when executed by the at least one processor, further cause the at least one processor to perform the steps of:
executing the updated first program code and the updated second program code;
determining, using the first trained machine learning model, that one or more additional errors during execution of the updated first program code and the updated second program code are caused by at least one of the updated first program code or the updated second program code; and
updating the at least one of the updated first program code or the updated second program code that caused the one or more additional errors to generate at least one of third program code or fourth program code.

18. The one or more non-transitory computer-readable media of claim 11, wherein the updated first program code simulates at least one portion of a video game level.

19. The one or more non-transitory computer-readable media of claim 11, wherein the one or more tests include one or more unit tests.

20. A system, comprising:
a memory storing instructions; and
one or more processors, that when executing the instructions, are configured to perform the steps of:
generating first program code that simulates an environment in which a robot can perform a task and second program code that includes one or more tests,
determining, using a first trained machine learning model, that one or more errors during execution of the first program code and the second program code are caused by at least one of the first program code or the second program code, and
updating the at least one of the first program code or the second program code based on the one or more errors to generate at least one of updated first program code or updated second program code.
